(19) United States
(12) Patent Application Publication
(10) Pub. No.: US 2003/0173348 A1
(43) Pub. Date: Sep. 18, 2003

(54) Lightwave oven with cooling duct

(76) Inventors: Martina Backer, Traunreut (DE); Wolfgang Fuchs, Altenmarkt A.D.Alz (DE); Bernhard Herold, Regensburg (DE); Katrin Horn, Traunreut (DE); Kurt Lintner, Nussdorf (DE); Andreas Nitschke, Tacherting (DE); Martin Schulte, Hagen (DE); Martin Thaler, Oberteisendorf (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/354,780

(22) Filed: Jan. 30, 2003

(30) Foreign Application Priority Data
Jan. 30, 2002 (DE) 102 03 607.1

(51) Int. Cl. F27D 11/00

(52) U.S. Cl. 219/405; 219/411

(57) ABSTRACT

A lightwave oven includes a cooking chamber, at least one wall having a translucent region, at least one duct separated from the chamber by the wall, the duct having at least one inlet opening supplying cooling air therein and at least one outlet opening discharging the cooling air, at least one lightwave heating device heating food in the chamber, the heating device having at least one rod-shaped radiant lamp producing lightwaves, the radiant lamp being disposed within the duct and having a longitudinal extent, and at least one reflector surface for reflecting the lightwaves produced by the radiant lamp into the chamber, and the inlet opening and the outlet opening being disposed to direct the cooling air in the duct to flow substantially at right angles to the longitudinal extent of the radiant lamp.

### BACKGROUND OF THE INVENTION

1. Field of the Invention

The invention relates to a lightwave oven having a cooking chamber and at least one lightwave heating device for heating food located in the cooking chamber including a rod-like or rod-shaped radiant lamp and at least one reflector surface for reflecting the lightwaves produced by the at least one radiant lamp into the cooking chamber, which radiant lamp is disposed within at least one duct which is separated from the cooking chamber by a wall having a translucent region.

Lightwave ovens are ovens that heat the food by visible and infrared radiation. As a result of the action of visible, virtually visible, and infrared radiation of high intensity on the food, a very rapid and high-quality cooking and baking method is provided. The cooking times lie approximately in the timeframe that is known from the use of microwave ovens, browning being achieved as known from conventional ovens.

A lightwave oven is disclosed, for example, by International publication WO 00/40912 A1, corresponding to U.S. Pat. No. 6,417,494 to Westerberg et al. In this prior art lightwave oven, an upper translucent top wall and a lower translucent bottom wall bound the cooking chamber. Above the translucent top wall, an upper lightwave heating device is disposed such that it can be moved to and fro in an upper duct separated from the cooking chamber. Underneath the translucent bottom wall, a lower lightwave heating device is disposed such that it can be moved to and fro in a lower duct separated from the cooking chamber. In the prior art lightwave ovens, the light/radiant sources used are tungsten quartz halogen lamps, such as quartz arc lamps. These lamps generally have to be cooled. Cooling is carried out, in particular, by cooling air.

### SUMMARY OF THE INVENTION

It is accordingly an object of the invention to provide a lightwave oven with cooling duct that overcomes the hereinafore-mentioned disadvantages of the heretofore-known devices of this general type and that improves the cooling of the lightwave heating devices in a lightwave oven. As a result, the lifetime of the radiant lamps is increased.

With the foregoing and other objects in view, there is provided, in accordance with the invention, a lightwave oven, including a cooking chamber for receiving food to be cooked, at least one wall having a translucent region, at least one duct separated from the cooking chamber by the at least one wall, the at least one duct having at least one inlet opening for supplying cooling air therein and at least one outlet opening for discharging the cooling air, at least one lightwave heating device for heating the food in the cooking chamber, the at least one lightwave heating device having at least one rod-shaped radiant lamp producing lightwaves, the at least one radiant lamp being disposed within the at least one duct and having a longitudinal extent and at least one reflector surface for reflecting the lightwaves produced by the at least one radiant lamp into the cooking chamber and the at least one inlet opening and the at least one outlet opening being disposed to direct the cooling air in the at least one duct to flow substantially at right angles to the longitudinal extent of the at least one radiant lamp.

Preferably, the reflector surface reflects the lightwaves produced by the at least one radiant lamp into the cooking chamber through the translucent region.

With the objects of the invention in view, in a lightwave oven having a cooking chamber for receiving food to be cooked and at least one wall with a translucent region, there is also provided a heating system including at least one duct separated from the cooking chamber by the at least one wall, the at least one duct having at least one inlet opening for supplying cooling air therein and at least one outlet opening for discharging the cooling air, at least one lightwave heating device for heating the food in the cooking chamber, the at least one lightwave heating device having at least one rod-shaped radiant lamp producing lightwaves, the at least one radiant lamp being disposed within the at least one duct and having a longitudinal extent and at least one reflector surface for reflecting the lightwaves produced by the at least one radiant lamp into the cooking chamber through the translucent region, and the at least one inlet opening and the at least one outlet opening being disposed to direct the cooling air in the at least one duct to flow substantially at right angles to the longitudinal extent of the at least one radiant lamp.

As a result of the particular cooling-air guidance, the radiant lamp or the radiant lamps are acted on particularly beneficially by cooling air, and the heat produced by the radiant lamps is dissipated in a larger quantity and more rapidly. This is because it has been shown that the cooling action is improved as the cooling air flows toward the rod-shaped radiant lamp at right angles to the longitudinal extent of the latter. In such a case, cold cooling air is applied uniformly to the rod-shaped radiant lamp. As a result of the perpendicular inflow, the cooling air stream is swirled, even at the front edge of an existing lamp reflector, such that the cooling air flows around the rod-shaped radiant lamp in the manner of a roll.

In accordance with another feature of the invention, a guide device is provided, by which the cooling air can be guided predominantly to the two ends of the rod-shaped radiant lamp. This is because it has been found that, for the lifetime of the radiant lamps, in particular, the region of the mount and/or the electrical connections is critical. In the case of rod-shaped radiant lamps, it is, therefore, advantageous if the two ends of the radiant lamps are cooled intensively to a particular extent. Because of the poor thermal conductivity properties of the electrically insulating materials of the lamp mounts, such as the ceramic materials normally used, the heat produced in these regions can be dissipated only poorly through the lamp mount and the electrical connecting contacts. Particularly intensive cooling of these regions, therefore, contributes to a prolonged lifetime of the radiant lamps.

In accordance with a further feature of the invention, the rod-shaped radiant lamps are, preferably, equipped with at least one reflector surface, which are constructed as channel-like or channel-shaped lamp reflectors and, extending along the length of the rod-shaped radiant lamps, surround the latter. The channel-shaped lamp reflector reflects lightwaves emitted by the radiant lamp into the cooking chamber and, at the same time, is used as a heat guide shield, that is to say, the lamp reflector picks up heat that has been discharged by the radiant lamp and passes the discharged heat onto the oven housing. However, it is less beneficial if the lamp reflector reaches around the radiant lamp to such an extent that cooling air supplied at right angles to the longitudinal extent of the radiant lamp is shielded. To prevent or at least reduce considerably the effect of the cooling air shielding, apertures can be provided on the lamp reflector, through which cooling air can be guided to the radiant lamps. The apertures in the lamp reflectors can have any desired shape. In such a case, it is necessary to take into account the fact that a considerable enlargement in the apertures results in an improved through flow of cooling air, but, at the same time, the size of the reflector surface is reduced and, therefore, the lightwaves are reflected less well. Too low a number of apertures or apertures that are too small may, possibly, not permit sufficiently good throughflow.

Sufficiently good throughflow with good reflection capability at the same time is provided in a configuration in which the apertures include a large number of holes, slots, or gills distributed uniformly over the area of the lamp reflector. In particular, the design with gills makes it possible to maintain the reflective capability to virtually the same extent as in the case of a reflector without aperture. At the same time, however, a sufficient throughflow is obtained.

Alternatively, the openings can be distributed non-uniformly over the surface of the reflector.

To obtain increased cooling at the two ends of the rod-shaped radiant lamp, the guide device is constructed as a baffle plate, which extends upward over the central length of the channel-shaped lamp reflector and is fixed to the latter. As a result of the baffle plate, the cooling air flowing in uniformly is urged to an increased extent in the direction of the ends of the channel-shaped lamp reflector. As such, cooling air is conveyed into these regions to an increased extent, and the cooling action is increased there.

So that the cooling action at the two ends of the rod-shaped radiant lamp is additionally improved, in accordance with an added feature of the invention, the apertures in the lamp reflector can include a large number of holes, slots, or gills that pierce the lamp reflector predominantly at the two ends of the channel-shaped lamp reflector. By using the number and size of the apertures and the distribution, the input of cooling air and the distribution of the cooling air between rod-shaped radiant lamp and the lamp reflector can be influenced in a suitable way.

The measures disclosed are particularly effective in the case of lightwave ovens that operate on the scanner principle, that is to say, in lightwave ovens having at least one lightwave heating device that can be moved to and fro. Such a scanner oven has an upper duct above the cooking chamber, in which a first lightwave heating device can be moved to and fro between a first position and a second position, and a lower duct, which is provided underneath the cooking chamber and in which a second lightwave heating device can be moved to and fro between a starting position and an end position.

To improve the reflection within the lightwave oven, in particular, if the lamp reflector has apertures that reduce the reflective capability of the lamp reflector, at least one duct can have walls whose inner sides, at least to some extent, have a light-reflecting surface. The light-reflecting surface can be built up from a large number of structural elements, in particular, from concave surface elements, sawtooth elements, microprisms, or as grating structures.

The structural elements can be formed in the marginal region of the bottom wall of the lower duct. The at least one light-reflecting surface can be formed as an aluminum mirror sheet or as a silvered metal sheet. These surfaces, preferably, reflect light in the spectral wavelength range between 400 and 1500 nm.

So that lightwaves cannot emerge from the inlet openings and the outlet openings for the cooling air, the inlet openings and/or the outlet openings have staircase-like or sawtooth-like duct sections. As a result, lightwaves that stream in the direction of the inlet openings and the outlet openings are reflected back into the cooking chamber again. The inner sides of the staircase-like or sawtooth-like duct sections, preferably, have light-reflecting surfaces.

Other features that are considered as characteristic for the invention are set forth in the appended claims.

Although the invention is illustrated and described herein as embodied in a lightwave oven with cooling duct, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a perspective view from above an oven housing of a lightwave oven according to the invention having a lightwave heating device that can be moved to and fro;

FIG. 2 is a diagrammatic cross-sectional view through the lightwave oven of FIG. 1;

FIG. 3 is a diagrammatic cross-sectional view through the lightwave oven of FIG. 1 with an illustration of light beams; and

FIG. 4 is a diagrammatic cross-sectional view through the lightwave oven of FIG. 1 with an illustration of cooling air flows.

### DESCRIPTION OF THE PREFERRED EMBODIMENTS

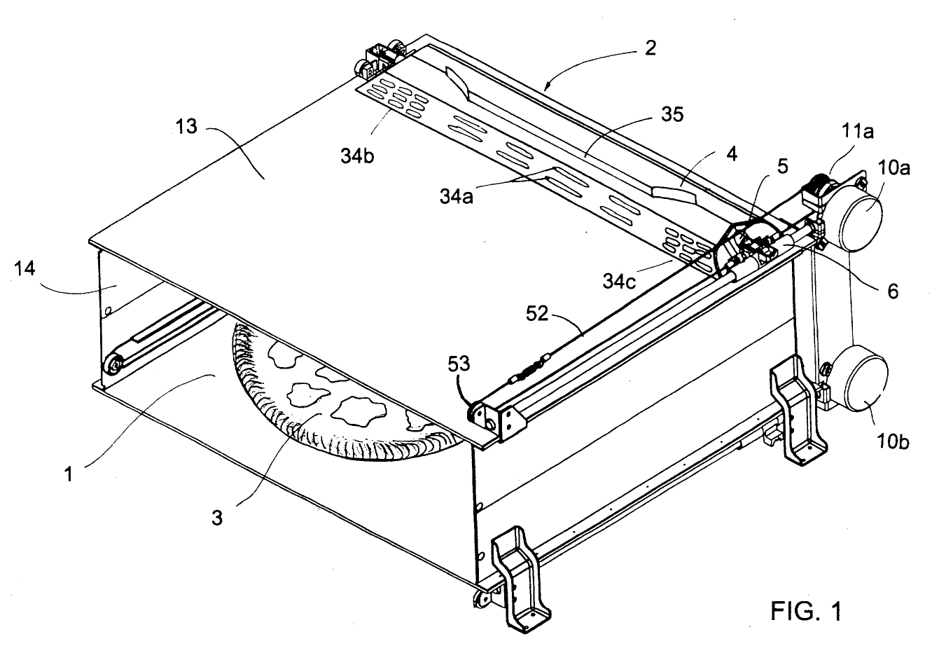

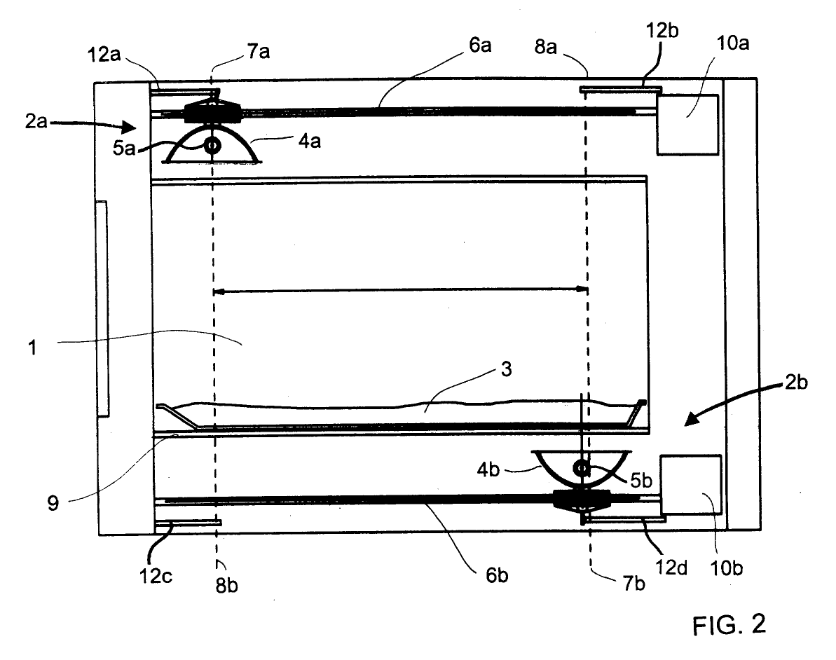

Referring now to the figures of the drawings in detail and first, particularly to FIG. 1 thereof, there is shown a preferred configuration of a lightwave oven having a lightwave heating device that can be moved to and fro. The cooling chamber 1 is enclosed by the oven housing 13 and has, at its front side, an opening 14 for the food 3 to be put into the cooking chamber 1. Above the cooking chamber 1 and underneath the cooking chamber 1, a lightwave heating device 2, 2a, 2b that can be moved to and fro is disposed in each case. See FIG. 2. The lightwave heating device 2a disposed above the cooking chamber 1 includes an upper radiant lamp 5a and an upper lamp reflector 4a. The lightwave heating device 2b disposed underneath the cooking chamber 1 includes a lower radiant lamp 5b and a lower lamp reflector 4b. Each lightwave heating device 2a, 2b is fixed to its own movement device 6a, 6b such that it can be moved to and fro. The upper movement device 6a is driven by a pull cable 52 and a deflection roller 53 and an upper gear mechanism 11a by the stepping motor 10a. The lower movement device 6b is driven in the same way as the upper movement device 6a but independently of the latter by the lower stepping motor 10b.

The lamp reflector 4 has apertures 34a to guide the cooling air to the radiant lamp 5. In the region of the ends of the lamp reflector 4, a larger number of smaller apertures 34b are disposed at the left-hand end of the lamp reflector 4, and apertures 34c are disposed at the right-hand end of the lamp reflector 4. A guide device 35 is fitted above the lamp reflector 4. The guide device 35 extends substantially only over a central region of the longitudinal extent of the lamp reflector 4. As a result, cooling air can be guided to a greater extent to the ends of the lamp reflector 4.

The schematic cross-section through the lightwave oven, illustrated in FIG. 2, shows the cooking chamber 1 with food 3 placed on the food support 9. The upper lightwave heating device 2a includes the radiant lamp 5a and the lamp reflector 4a. The lower lightwave heating device 2b includes the radiant lamp 5b and the lamp reflector 4b. The upper lightwave heating device 2a can be moved to and fro on a travel path from a first position 7a into a second position 8a by the movement device 6a. The movement device 6a is driven by the stepping motor 10a. The lower lightwave heating device 2b can be moved to and fro on a travel path from a first position 7b into a second position 8b by the movement device 6b. The movement device 6b is driven by the stepping motor 10b. A limit switch 12a takes care of a signal to reverse the movement of the upper lightwave heating device 2a in the first position 7a. A limit switch 12b takes care of a signal for reversing the movement of the upper lightwave heating device 2a in the second position 8a. A limit switch 12c takes care of a signal to reverse the movement of the lower lightwave heating device 2b in the second position 8b. A limit switch 12d takes care of a signal for reversing the movement of the lower lightwave heating device 2b in the first position 7b.

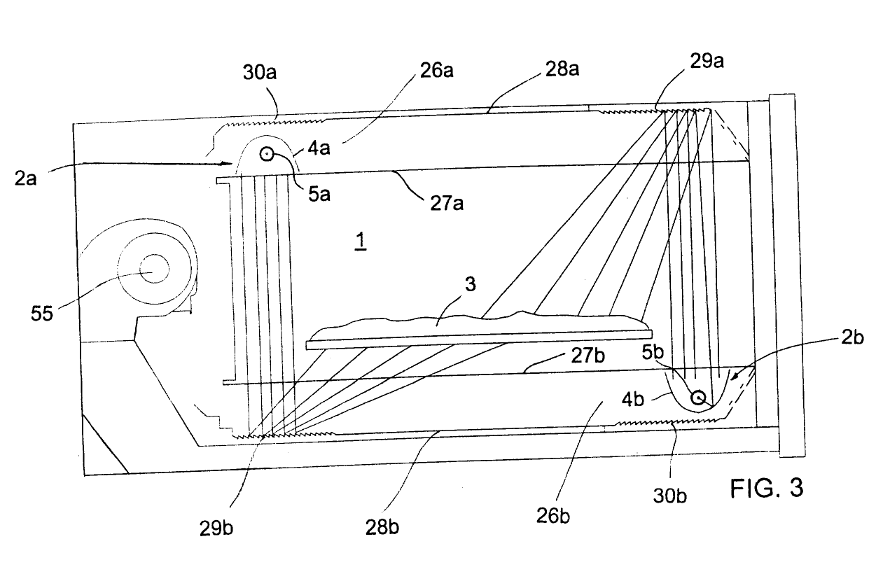

The course of a light beam through the lightwave oven is shown in the schematic cross-section in FIG. 3. The upper lightwave heating device 2a includes the radiant lamp 5a and the lamp reflector 4a. The lower lightwave heating device 2b includes the radiant lamp 5b and the lamp reflector 4b. The fan 55 draws cooling air in from the surroundings and conveys the cooling air into the upper duct 26a and into the lower duct 26b. The upper duct 26a is bounded at the bottom by a translucent screen 27a and at the top by a top-side wall 28a. In this duct 26a, the cooling air flows at right angles to the alignment of the lightwave heating device 2a. At a first end of the travel path for the lightwave heating device 2a in the duct 26a, structural elements 29a are fitted to the upper topside wall 28a. At the second end of the travel path for the lightwave heating device 2a in the duct 26a, structural elements 30a are located or disposed at or fitted to the upper top-side wall 28a. The lower duct 26b is bounded at the top by a translucent screen 27b and at the bottom by a bottom-side wall 28b. In this duct 26b, the cooling air flows at right angles to the alignment of the lightwave heating device 2b. At the first end of the travel path for the lightwave heating device 2b in the duct 26b, structural elements 29b are fitted to the lower bottom-side wall 28b. At the second end of the travel path for the lightwave heating device 2b in the duct 26b, structural elements 30b are located or disposed at or fitted to the lower bottom-side wall 28a.

The structural elements 29a, 29b, 30a, 30b reflect light that is emitted by the radiant lamps 5a and 5b and not absorbed by the food 3 back into the center of the cooking chamber 1 in the direction of the food 3 again. Such back reflection of light is necessary, in particular, in the edge region of the cooking chamber 1 so that light that streams past the food and onto the opposite reflective wall in the cooking chamber 1 is not reflected directly back into the radiant lamp 5a, 5b that has emitted the light radiation. This is because if emitted light were to stream directly back, the radiant lamps 5a, 5b would, additionally, be heated unnecessarily. Reflecting emitted light in the direction of the center of the cooking chamber, thus, avoids additional heating of the radiant lamps 5a and 5b.

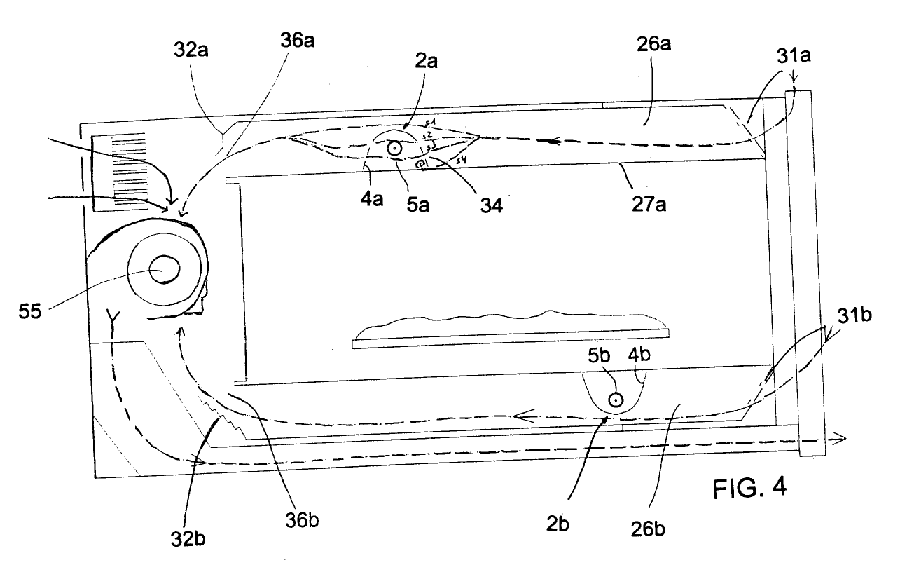

FIG. 4 shows a schematic cross-section through the lightwave oven with an illustration of the course of a cooling air flow. The fan 55 sucks cooling air out of the surroundings through inlet openings 31a, for example, and conveys the cooling air into the upper duct 26a and into the lower duct 26b. In these ducts 26a and 26b, the cooling air flows at right angles to the alignment of the lightwave heating device 2a and 2b. Air flowing through the ducts 26a, 26b flows out of the ducts 26a, 26b through outlet openings 36a, 36b, which, for example, can open into staircase-shaped or sawtooth-shaped duct sections 32a, 32b.

Various flow paths S1, S2, S3, and S4 are shown on the upper lamp reflector 4a. Due to the apertures 34, the flow paths S2 and S3 run through the reflector 4a and the cooling air running along these flow paths S2 and S3 cools the rod-shaped radiant lamp 5a. The flow path S4 runs between the translucent screen 27a and the front edge of the lamp reflector 4a. Cooling air that takes this flow path S4 penetrates into the interior of the reflector 5 and swirls behind the front edge of the lamp reflector 4a. In the process, the cooling air is swirled and mixes with the cooling air that has passed the interior of the lamp reflector 4a through the flow paths S2 and S3. As a result, a turbulent flow, which cools particularly effectively, is obtained in the interior of the lamp reflector 4a. Some of the cooling air flows over the lamp reflector 4a in accordance with the flow path S1. If a guide device 35 is used, such as that illustrated, for example, in FIG. 1, the cooling air that flows away over the lamp reflector 4a through the flow path S1 can be guided into the region of the ends of the rod-shaped radiant lamp 5a, in order to cool, in particular, the ends of the rod-shaped radiant lamp 5a.

We claim:

1. A lightwave oven, comprising:
a cooking chamber for receiving food to be cooked;
at least one wall having a translucent region;
at least one duct separated from said cooking chamber by said at least one wall, said at least one duct having at least one inlet opening for supplying cooling air therein and at least one outlet opening for discharging the cooling air;
at least one lightwave heating device for heating the food in said cooking chamber, said at least one lightwave heating device having:
at least one rod-shaped radiant lamp producing lightwaves, said at least one radiant lamp being disposed within said at least one duct and having a longitudinal extent; and
at least one reflector surface for reflecting the lightwaves produced by said at least one radiant lamp into said cooking chamber; and
said at least one inlet opening and said at least one outlet opening being disposed to direct the cooling air in said at least one duct to flow substantially at right angles to said longitudinal extent of said at least one radiant lamp.

2. The lightwave oven according to claim 1, wherein:
said at least one radiant lamp has two ends; and
a guide device guides the cooling air predominantly towards said two ends.

3. The lightwave oven according to claim 1, wherein:
said at least one lightwave heating device has a guide device;
said at least one radiant lamp has two ends; and
said guide device guides the cooling air predominantly towards said two ends.

4. The lightwave oven according to claim 2, wherein:
said at least one reflector surface is at least one channel-shaped lamp reflector; and
said at least one radiant lamp is surrounded along said longitudinal extent by at least one lamp reflector.

5. The lightwave oven according to claim 4, wherein said at least one lamp reflector has apertures through which the cooling air is guided to said at least one radiant lamp.

6. The lightwave oven according to claim 4, wherein:
said at least one lamp reflector has a surface;
said apertures are a number of openings selected from a group consisting of holes, slots, and gills; and
said openings are distributed uniformly over said surface of said at least one lamp reflector.

7. The lightwave oven according to claim 4, wherein:
said at least one lamp reflector has a surface;
said apertures are a number of openings selected from a group consisting of holes, slots, and gills; and
said openings are distributed non-uniformly over said surface of said at least one lamp reflector.

8. The lightwave oven according to claim 4, wherein:
said at least one lamp reflector has a central length; and
said guide device is a baffle plate extending upward over said central length and is fixed to said at least one lamp reflector.

9. The lightwave oven according to claim 4, wherein said guide device is a baffle plate fixed to said at least one lamp reflector and extending radially away from said at least one lamp reflector.

10. The lightwave oven according to claim 5, wherein:
said at least one lamp reflector has two ends; and
said apertures are a number of openings selected from a group consisting of holes, slots, and gills, said holes piercing said at least one lamp reflector and being predominately disposed at said two ends thereof.

11. The lightwave oven according to claim 6, wherein said openings pierce said at least one lamp reflector.

12. The lightwave oven according to claim 7, wherein said openings pierce said at least one lamp reflector.

13. The lightwave oven according to claim 1, wherein said at least one lightwave heating device is movably disposed in said cooking chamber along a travel path and moves to and fro along said travel path.

14. The lightwave oven according to claim 1, wherein:
said at least one duct is two ducts including an upper duct disposed above said cooking chamber and a lower duct disposed below said cooking chamber; and
said at least one lightwave heating device is two lightwave heating devices including:
a first lightwave heating device movably disposed in said upper duct between a first position and a second position, said first lightwave heating device moves to and fro in said upper duct between said first and second positions; and
a second lightwave heating device movably disposed in said lower duct between a starting position and an ending position, said second lightwave heating device moves to and fro in said lower duct between said starting and ending positions.

15. The lightwave oven according to claim 1, wherein:
said cooking chamber has sides;
said at least one duct is two ducts disposed at said sides of said cooking chamber; and
said at least one lightwave heating device is two lightwave heating devices including:
a first lightwave heating device movably disposed in a first of said ducts between a first position and a second position; and
a second lightwave heating device movably disposed in a second of said ducts between a starting position and an ending position; and
said first lightwave heating device moves to and fro in said first duct between said first and second positions and said second lightwave heating device moves to and fro in said second duct between said starting and ending positions.

16. The lightwave oven according to claim 1, wherein:
said at least one duct has walls with inner sides; and
said inner sides at least partially have a light-reflecting surface.

17. The lightwave oven according to claim 16, wherein said light-reflecting surface is built up from a number of structural elements.

18. The lightwave oven according to claim 16, wherein said light-reflecting surface includes a number of structural elements.

19. The lightwave oven according to claim 18, wherein said structural elements are elements selected from a group consisting of concave surface elements, sawtooth elements, microprisms, and a grating structure.

20. The lightwave oven according to claim 18, wherein:
said at least one duct is at least two ducts including an upper duct disposed above said cooking chamber and having a top-side wall with end regions; and
said structural elements are formed in at least one of said end regions.

21. The lightwave oven according to claim 16, wherein at least one of said at least one inlet opening and said at least one outlet opening open into one of a staircase-shaped duct section and a sawtooth-shaped duct section.

22. The lightwave oven according to claim 16, wherein:
said at least one duct has at least one duct section selected from a group consisting of a staircase-shaped duct section and a sawtooth-shaped duct section; and
at least one of said at least one inlet opening and said at least one outlet opening open into said duct section.

23. The lightwave oven according to claim 22, wherein said duct section has inner sides with light-reflecting surfaces.

24. The lightwave oven according to claim 21, wherein at least one of said duct sections has inner sides with light-reflecting surfaces.

25. The lightwave oven according to claim 1, wherein said at least one reflector surface reflects the lightwaves produced by said at least one radiant lamp into said cooking chamber through said translucent region.

26. In a lightwave oven having a cooking chamber for receiving food to be cooked and at least one wall with a translucent region, a heating system comprising:
at least one duct separated from the cooking chamber by the at least one wall, said at least one duct having at least one inlet opening for supplying cooling air therein and at least one outlet opening for discharging the cooling air;
at least one lightwave heating device for heating the food in the cooking chamber, said at least one lightwave heating device having:
at least one rod-shaped radiant lamp producing lightwaves, said at least one radiant lamp being disposed within said at least one duct and having a longitudinal extent; and
at least one reflector surface for reflecting the lightwaves produced by said at least one radiant lamp into the cooking chamber through the translucent region; and
said at least one inlet opening and said at least one outlet opening being disposed to direct the cooling air in said at least one duct to flow substantially at right angles to said longitudinal extent of said at least one radiant lamp.
